(19) United States
(12) Patent Application Publication
(10) Pub. No.: US 2025/0335202 A1
(43) Pub. Date: Oct. 30, 2025

(54) GRAPH TASK SCHEDULING METHOD, EXECUTION-END DEVICE, STORAGE MEDIUM, AND PROGRAM PRODUCT

(71) Applicant: Cambricon Technologies Corporation Limited, Beijing (CN)

(72) Inventors: Yanqiang GAO, Beijing (CN); Qinglong CHAI, Beijing (CN); Yingnan ZHANG, Beijing (CN)

(21) Appl. No.: 18/574,516

(22) PCT Filed: Jul. 1, 2022
(86) PCT No.: PCT/CN2022/103464

§ 371 Date: Jun. 6, 2024

(30) Foreign Application Priority Data
Sep. 22, 2021 (CN) 202111108264.5

(51) Int. Cl. G06F 9/38

(52) U.S. Cl. CPC G06F 9/3838

(57) ABSTRACT

By adopting the graph task scheduling method, the execution-end device, the storage medium, and the program product provided by embodiments of the present disclosure, the task execution state of the predecessor task having a dependency relationship with the current task is determined; whether to execute the current task according to the task execution state of the predecessor task and the task execution state of the current task is determined, where if the current task is determined to be executed, the task execution state of the current task is updated after the current task is executed, so that the execution-end device directly obtains the task execution state of the predecessor task of the current task before executing the current task, realizing the graph task scheduling processing on the execution-end device, thereby eliminating the need for the host-end device to perform task scheduling, reducing communication overhead and improving task operation efficiency.

The present application claims priority from Chinese patent application No. 202111108264.5 titled “GRAPH TASK SCHEDULING METHOD, EXECUTION-END DEVICE, STORAGE MEDIUM, AND PROGRAM PRODUCT” and filed on Sep. 22, 2021, the disclosure of which is incorporated herein in its entirety by reference.

### TECHNICAL FIELD

Embodiments of the present disclosure relate to the field of data processing technology, and particularly relate to a method for scheduling graph task, an execution device, a storage medium, and a program product.

### BACKGROUND

A graph task refers to a task represented by a graph structure. Each node in a graph structure corresponding to a graph task represents a task, and directed edges formed between nodes represent dependencies between tasks.

During the process of processing a graph task, generally, each task is sequentially sent to an execution device (abbreviated as a device) through a host device (abbreviated as a host), and a processing unit of the device executes each task. After completing a task, the execution device may return an execution result to the host device to enable the host device to launch a next task to the execution device.

However, with the increase in the number of tasks in the graph task and the complexity of the graph task, such a task scheduling method requires a lot of time in the scheduling communication between the execution device and the host device, and its overall task processing efficiency is severely affected.

### SUMMARY

Embodiments of the present disclosure provide a method for scheduling graph task, an execution device, a storage medium, and a program product to solve the problem of low task processing efficiency caused by high communication overhead in the scheduling process in the existing method for scheduling graph task.

A first aspect of the present disclosure provides a method for scheduling graph task, which includes: determining a task execution state of a predecessor task having a dependency relationship with a current task; determining whether to execute the current task according to the task execution state of the predecessor task and a task execution state of the current task; and updating the task execution state of the current task after the current task is executed if the current task is determined to be executed.

In optional embodiments, task execution states of different tasks are stored in different register bits of a register; when the register bit is recorded as a first state value, the task execution state of a task corresponding to the register bit is a finished state; and when the register bit is recorded as a second state value, the task execution state of the task corresponding to the register bit is an unfinished state.

In optional embodiments, determining whether to execute the current task according to the task execution state of the predecessor task and the task execution state of the current task includes: acquiring a register bit of the predecessor task and a register bit of the current task in the register; and executing the current task when the register bit of the predecessor task is recorded as a first state value and the register bit of the current task is recorded as a second state value.

In optional embodiments, updating the task execution state of the current task after the current task is executed includes: updating the register bit of the current task to the first state value.

In optional embodiments, the method may further include: obtaining an execution state updating identifier in a task descriptor of the current task; and updating the task execution state of the current task according to the execution state updating identifier of the current task after the current task is executed.

In optional embodiments, the method may further include: obtaining an execution state checking identifier in the task descriptor of the current task; and determining a task execution state of the predecessor task having a dependency relationship with the current task according to the execution state checking identifier of the current task.

In optional embodiments, if it is determined that the current task cannot be executed based on the task execution state of the predecessor task and the task execution state of the current task, the step is returned to the determining the task execution state of the predecessor task having a dependency relationship with the current task until it is determined that the current task can be executed based on the task execution state of the predecessor task and the task execution state of the current task.

In optional embodiments, the method may further include: obtaining a task descriptor of each task in the graph task, where the task descriptor contains dependency relationship information between tasks in the graph task; and determining a predecessor task having a dependency relationship with the current task according to the task descriptor of each task in the graph task.

A second aspect of the present disclosure provides a computer system including a host device and an execution device.

The host device is configured to configure a task descriptor for a graph task and launch the graph task and the corresponding task descriptor of the graph task to the execution device, where the task descriptor contains dependency relationship information between tasks in the graph task.

The execution device is configured to determine a task execution state of a predecessor task having a dependency relationship with a current task. The execution device is further configured to determine whether to execute the current task according to the task execution state of the predecessor task and a task execution state of the current task, where if the current task is determined to be executed, the execution device is configured to update the task execution state of the current task after the current task is executed.

A third aspect of the present disclosure provides an execution device including a memory and a processor.

The memory is configured to store instructions executable by the processor.

The processor is configured to determine a task execution state of a predecessor task having a dependency relationship with a current task; determine whether to execute the current task according to the task execution state of the predecessor task and the task execution state of the current task; and update the task execution state of the current task after the current task is executed if the current task is determined to be executed.

A fourth aspect of the present disclosure provides a computer-readable storage medium, on which a computer execution instruction is stored, where the method for scheduling graph task as described in any one of the first aspect is implemented when the computer execution instruction is executed by a processor.

A fifth aspect of the present disclosure provides a computer program product including a computer program that, when executed by a processor, implements the method for scheduling graph task as described in any one of the first aspect.

By adopting the method for scheduling graph task, the execution device, the storage medium, and the program product provided by embodiments of the present disclosure, the task execution state of the predecessor task having a dependency relationship with the current task is determined; whether to execute the current task according to the task execution state of the predecessor task and the task execution state of the current task is determined, where if the current task is determined to be executed, the task execution state of the current task is updated after the current task is executed, so that the execution device may directly obtain the task execution state of the predecessor task of the current task before executing the current task, realizing graph task scheduling processing on the execution device, thereby eliminating the need for the host device to perform task scheduling for the execution of tasks of the execution device, reducing communication overhead and improving task operation efficiency.

### BRIEF DESCRIPTION OF DRAWINGS

The accompanying drawings herein, which are incorporated into and form a part of the specification, illustrate embodiments consistent with the present application and are used in conjunction with the specification to explain the principles of the present application.

FIG. 1 is a structural diagram of a board card 10 according to an embodiment of the present disclosure.

FIG. 2 is a structural diagram of a combined processing apparatus in a chip 101 according to an embodiment of the present disclosure.

FIG. 3 is a schematic diagram of an internal structure of a computing apparatus 201 having a single core.

FIG. 4 is a schematic diagram of an internal structure of a computing apparatus 201 having multiple cores.

FIG. 5 is a schematic diagram of an internal structure of an IPU (Intelligent Processing Unit) core according to an embodiment of the present disclosure.

FIG. 6 is a schematic diagram of a graph structure of a graph task.

FIG. 7 is a flow chart of a method for scheduling graph task in the prior art.

FIG. 8 is a flow chart of a method for scheduling graph task provided by the present application.

FIG. 9 is a schematic diagram of a hardware structure of a computer system provided by the present application.

Through the above-mentioned drawings, clear embodiments of the present application have been shown, which will be described in more detail below. These drawings and textual descriptions are not intended in any way to limit the scope of the ideas presented in the present application, but rather to illustrate the concepts of the present application for those skilled in the art by reference to specific embodiments.

### DETAILED DESCRIPTION OF EMBODIMENTS

Exemplary embodiments will be described in detail herein, examples of which are represented in the accompanying drawings. Unless otherwise indicated, where the following description relates to the accompanying drawings, the same numerals in the different accompanying drawings indicate the same or similar elements. The embodiments described in the following exemplary embodiments do not represent all embodiments consistent with the present application. Rather, they are merely examples of devices and methods that are consistent with some aspects of the present application as detailed in the appended claims.

In the existing graph task scheduling process, a host device (abbreviated as a host) launches each task in the graph task to an execution device (abbreviated as a device) in turn and executes the task, and the execution device returns a task execution result to the host device after completing the execution of each task, which leads to a large communication overhead between the execution device and the host device, and the efficiency of the task processing is seriously affected. In order to solve the above problems, the present application provides a method for scheduling graph task, an execution device, a storage medium, and a program product.

The present application provides a method for scheduling graph task supported by the execution device. By inserting operations such as checking or updating the task execution state in the graph task, the execution device may automatically determine the task execution state of the predecessor task having a dependency relationship with the current task in the graph task; the execution device may determine whether to execute the current task according to the task execution state of the predecessor task and the task execution state of the current task, where if the current task is determined to be executed, the execution device may update the task execution state of the current task after the current task is executed, so that the execution device may directly obtain the task execution state of the predecessor task of the current task before executing the current task, realizing graph task scheduling processing on the execution device, thereby eliminating the need for the host device to perform task scheduling for the execution of tasks of the execution device, reducing communication and IO (input and output) overhead and improving task operation efficiency.

The method and the device are based on the same application conception, and since the method and the device solve problems on similar principles, the implementation of the device and the method can be seen in each other, and the repetition will not be repeated.

For the sake of illustration, computer hardware structures involved in the present application will be described first.

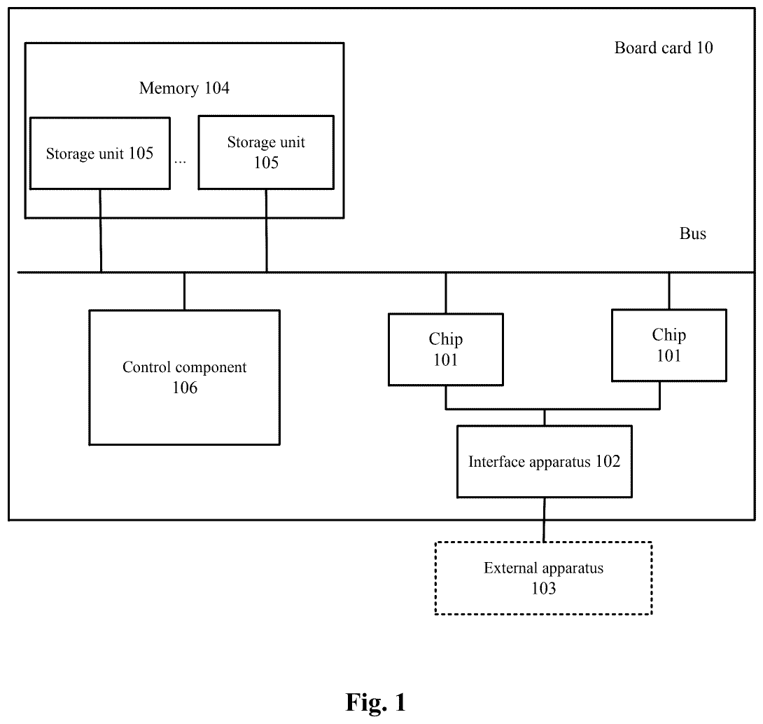

FIG. 1 is a structural diagram of a board card 10 according to an embodiment of the present disclosure. The board card may be used as the execution device mentioned above. As shown in FIG. 1, the board card 10 includes a chip 101, which is an SoC (system-on-chip), or it is called an on-chip system. The chip 101 is integrated with one or more combined processing apparatuses, where the combined processing apparatus is an artificial intelligence operation unit used to support various types of deep learning and machine learning algorithms to meet the intelligent processing requirements in complex scenarios in the fields of computer vision, speech, natural language processing, data mining, and the like. In particular, deep learning technology is widely applied in the field of cloud intelligence. A prominent feature of cloud intelligence application is the large amount of input data, which has high requirements on the storage capacity and computing power of a platform. The board card 10 of this embodiment is suitable for the cloud intelligence application. The board card 10 of this embodiment has huge off-chip storage, huge on-chip storage, and a lot of computing power.

The chip 101 is connected to an external apparatus 103 through an external interface apparatus 102. The external apparatus 103 may be, for example, a server, a computer, a camera, a monitor, a mouse, a keyboard, a network card, or a WIFI interface. To-be-processed data may be transferred from the external apparatus 103 to the chip 101 through the external interface apparatus 102. A computation result of the chip 101 may also be transferred by the external interface apparatus 102 back to the external apparatus 103. According to different application scenarios, the external interface apparatus 102 may have different interface forms, such as a PCIE (peripheral component interconnect express) interface.

The board card 10 further includes a memory 104 used for storing data, which includes one or a plurality of storage units 105. The memory 104 may connect to and transfer data to a control component 106 and the chip 101 through a bus. The control component 106 in the board card 10 may be configured to regulate and control a state of the chip 101. As such, in an application scenario, the control component 106 may include an MCU (Micro Controller Unit).

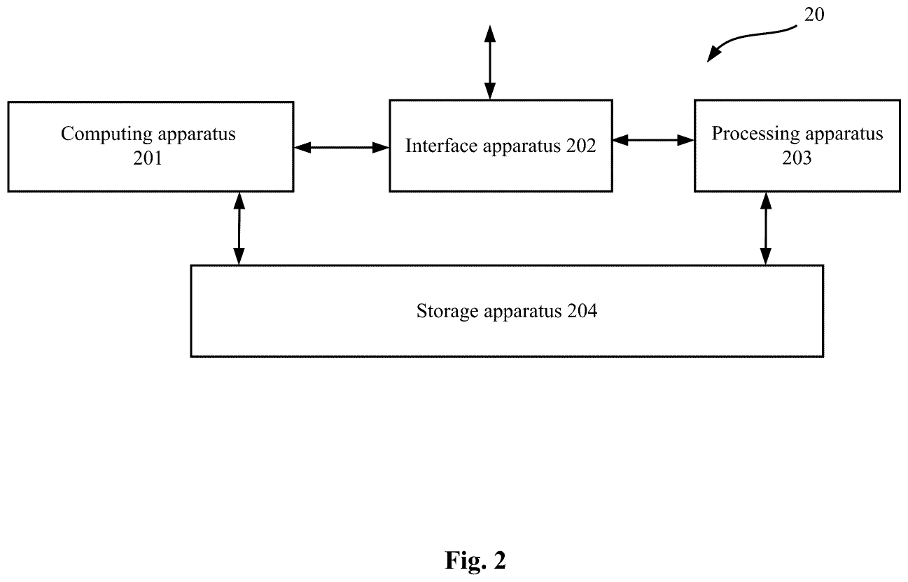

FIG. 2 is a structural diagram of a combined processing apparatus in the chip 101 according to an embodiment of the present disclosure. As shown in FIG. 2, a combined processing apparatus 20 includes a computing apparatus 201, an interface apparatus 202, a processing apparatus 203, and a storage apparatus 204.

The computing apparatus 201 is configured to perform an operation specified by a user. The computing apparatus 201 is mainly implemented as a single-core intelligent processor or a multi-core intelligent processor. The computing apparatus 201 is used for performing deep learning computing or machine learning computing. The computing apparatus 201 interacts with the processing apparatus 203 through the interface apparatus 202 to jointly complete the operation specified by the user.

The interface apparatus 202 is used to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire the control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general-purpose processing apparatus, and performs basic controls that include, but are not limited to, moving data, starting and/or stopping of the computing apparatus 201. According to different implementations, the processing apparatus 203 may be one or more kinds of general-purpose and/or special-purpose processors, including a CPU (central processing unit), a GPU (graphics processing unit), and the like. These processors include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The storage apparatus 204 is used for storing to-be-processed data, which may be a DRAM (Dynamic Random Access Memory). The storage apparatus 204 is a DDR (Double Data Rate) memory with a size of 16G or more than 16G generally. The storage apparatus 204 is used for saving data of the computing apparatus 201 and/or the processing apparatus 203.

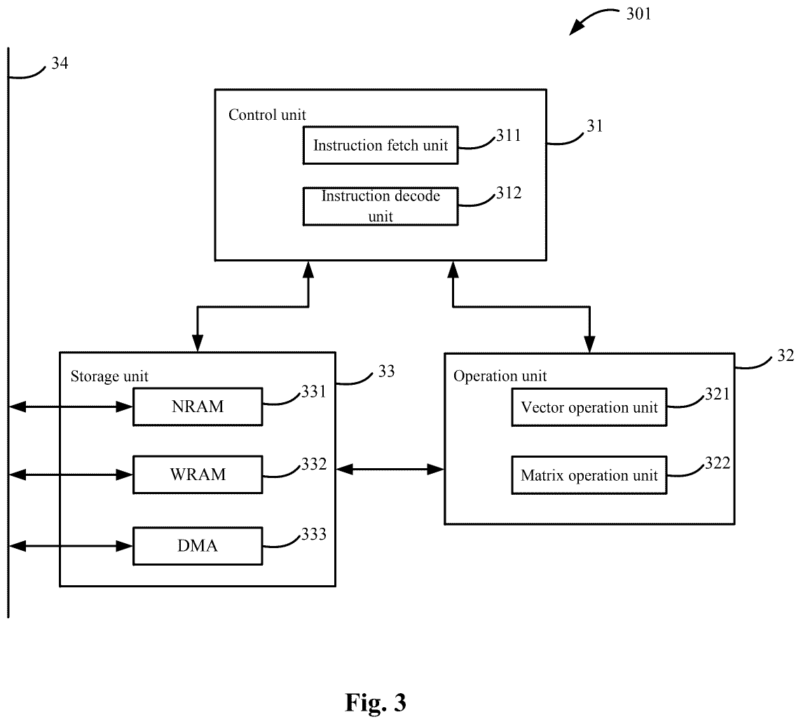

FIG. 3 is a schematic diagram of an internal structure of a computing apparatus 201 having a single core. A single-core computing apparatus 301 is configured to process input data involving computer vision, speech, natural language, data mining, and the like. The single-core computing apparatus 301 includes three units, which are a control unit 31, an operation unit 32, and a storage unit 33.

The control unit 31 is configured to coordinate and control the work of the operation unit 32 and the storage unit 33 to finish a deep learning task. The control unit 31 includes an IFU (instruction fetch unit) 311 and an IDU (instruction decode unit) 312. The instruction fetch unit 311 is configured to acquire an instruction from the processing apparatus 203. The instruction decode unit 312 is configured to decode the instruction acquired and send a decoding result as control information to the operation unit 32 and the storage unit 33.

The operation unit 32 includes a vector operation unit 321 and a matrix operation unit 322. The vector operation unit 321 is used to perform a vector operation, and may support complex operations such as vector multiplication, addition, and nonlinear transformation. The matrix operation unit 322 is responsible for the core computation of the deep learning algorithm, i.e., matrix multiplication and convolution.

The storage unit 33 is used to store or move relevant data and includes an NRAM (neuron RAM) 331, a WRAM (weight RAM) 332, and a DMA (direct memory access) 333. The NRAM 331 is used to store an input neuron, an output neuron and an intermediate result after computation; the WRAM 332 is used to store a convolution kernel of a deep learning network, i.e., a weight; and the DMA 333 is connected to the DRAM 204 through a bus 34, and is responsible for data transfer between the single-core computing apparatus 301 and the DRAM 204.

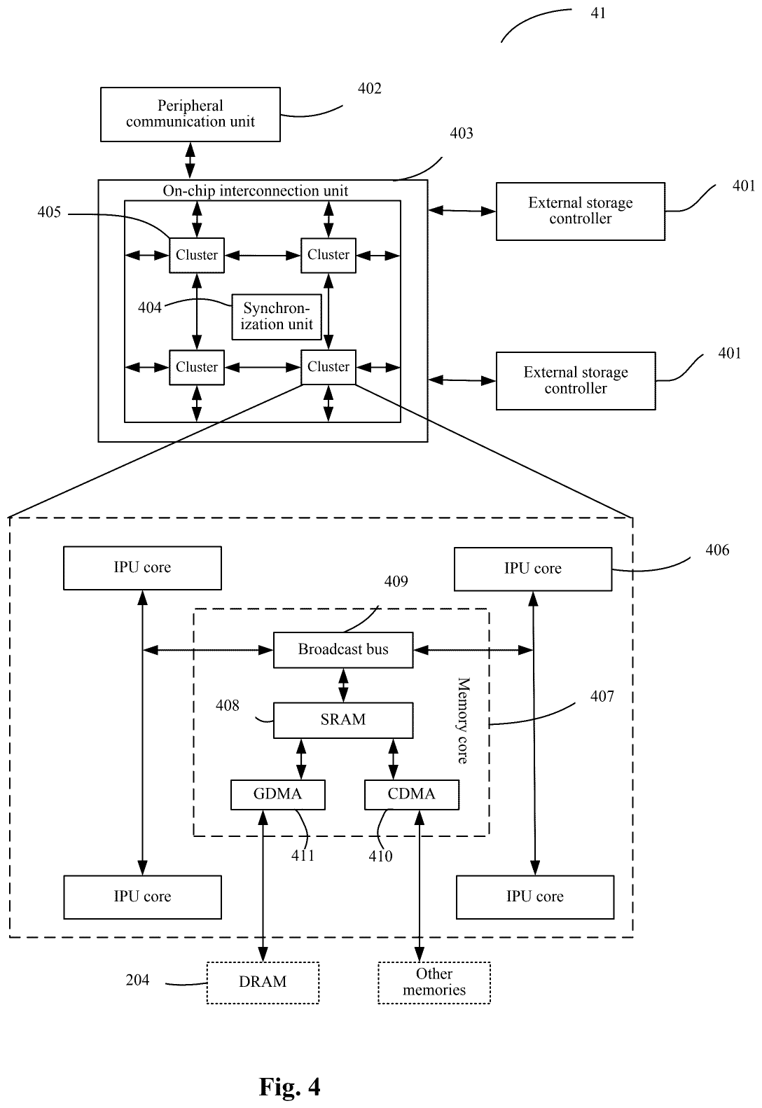

FIG. 4 is a schematic diagram of an internal structure of a computing apparatus 201 having multiple cores. A multi-core computing apparatus 41 is designed in a hierarchical structure. The multi-core computing apparatus 41 serves as an SoC, which includes at least one cluster. Each cluster further includes a plurality of IPU cores. In other words, the multi-core computing apparatus 41 is composed of an SoC-cluster-IPU core hierarchy.

In terms of the SoC hierarchy, as shown in FIG. 4, the multi-core computing apparatus 41 includes an external storage controller 401, a peripheral communication unit 402, an on-chip interconnection unit 403, a synchronization unit 404, and a plurality of clusters 405.

There may be a plurality of external storage controllers 401, two of which are exemplarily shown in the figure. The external storage controllers 301 are configured to, in response to an access request from the IPU cores, access an external storage apparatus, such as the DRAM 204 in the FIG. 2, so as to read or write data off-chip. The peripheral communication unit 402 is configured to receive a control signal from the processing apparatus 203 through the interface apparatus 202 to start the computing apparatus 201 to perform a task. The on-chip interconnection unit 403 connects the external storage controller 401, the peripheral communication unit 402, and the plurality of clusters 405, and is used for transferring data and the control signal among the units. The synchronization unit 404 is a GBC (global barrier controller), and is used to coordinate the work progress of each cluster to ensure the synchronization of information. The plurality of clusters 405 are computing cores of the multi-core computing apparatus 41, four of which are exemplarily shown in the figure. With the development of hardware, the multi-core computing apparatus 41 of the present disclosure may also include 8, 16, 64, or even more clusters 405. The clusters 405 are configured to efficiently execute deep learning algorithms.

In terms of the cluster hierarchy, as shown in FIG. 4, each cluster 405 includes a plurality of IPU cores (IPU (Intelligent Processing Unit) cores) 406 and a memory core (MEM core) 407.

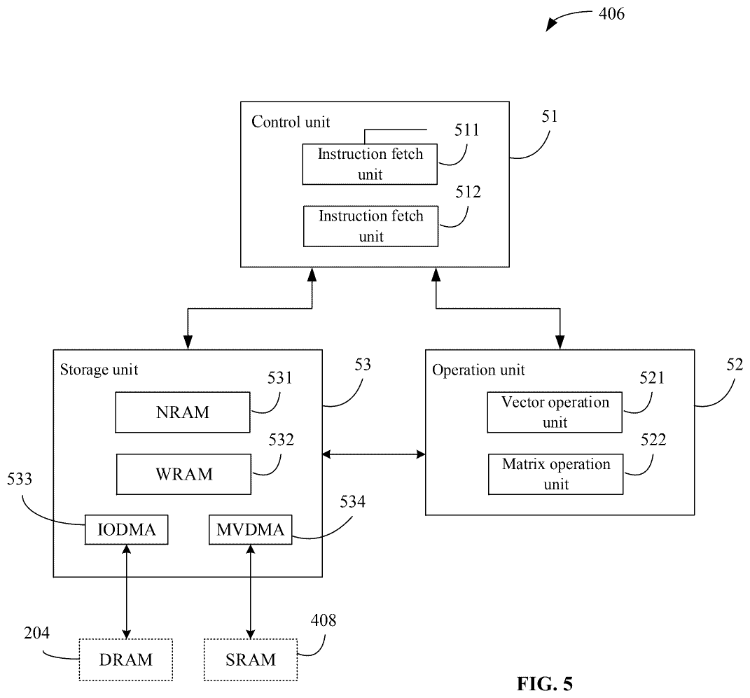

Four IPU cores 406 are exemplarily shown in the figure. The present disclosure does not limit the number of IPU cores 406. The internal architecture of the IPU core is shown in FIG. 5. Each IPU core 406 is similar to the single-core computing apparatus 301 shown in FIG. 3, and also includes three units: a control unit 51, an operation unit 52 and a storage unit 53. Functions and structures of the control unit 51, the operation unit 52 and the storage unit 53 are generally the same as those of the control unit 31, the operation unit 32 and the storage unit 33, and will not be repeated herein. It should be noted that the storage unit 53 includes an IODMA (input/output direct memory access) 533 and an MVDMA (move direct memory access) 534. The IODMA 533 controls memory access of an NRAM 531/WRAM 532 and the DRAM 204 through a broadcast bus 409; the MVDMA 534 is used to control memory access of the NRAM 531/WRAM 532 and a storage unit (SRAM) 408.

Going back to FIG. 4, the memory core 407 is primarily used for storage and communication; in other words, the memory core 407 is primarily used to store shared data or intermediate results among the IPU cores 406 and execute communication between the clusters 405 and the DRAM 204, communication between each cluster 405 and each other cluster 405, and communication between each IPU core 406 and each other IPU core 406. In other embodiments, the memory core 407 has the ability to perform a scalar operation, and is used to perform the scalar operation.

The memory core 407 includes an SRAM (shared RAM) 408, the broadcast bus 409, a CDMA (cluster direct memory access) 410 and a GDMA (global direct memory access) 411. The SRAM 408 plays the role of a high-performance data transfer station. Data multiplexed among different IPU cores 406 in a same cluster 405 is not required to be acquired separately from the DRAM 204 through the IPU cores 406, but is transferred among the IPU cores 406 through the SRAM 408. The memory core 407 is only required to quickly distribute the multiplexed data from the SRAM 408 to the plurality of IPU cores 406 to improve inter-core communication efficiency and greatly reduce on-chip and off-chip input/output access.

The broadcast bus 409, the CDMA 410, and the GDMA 411 are used to perform the communication among the IPU cores 406, the communication among the clusters 405, and data transmission between the clusters 405 and the DRAM 204, respectively, which will be described separately below.

The broadcast bus 409 is used to complete high-speed communication among the IPU cores 406 in the clusters 405. The broadcast bus 409 of the embodiment supports inter-core communication including unicast, multicast, and broadcast. The unicast refers to point-to-point (such as a single IPU core to a single IPU core) data transmission; the multicast refers to a communication mode in which a piece of data is transferred from the SRAM 408 to certain IPU cores 406; and the broadcast refers to a communication mode in which a piece of data is transferred from the SRAM 408 to all IPU cores 406. The broadcast is a special case of the multicast.

The CDMA 410 is used for controlling memory access of the SRAM 408 among different clusters 405 in the same computing apparatus 201.

The GDMA 411 works in conjunction with the external storage controller 401 to control the access from the SRAM 408 in the clusters 405 to the DRAM 204, or to read data from the DRAM 204 to the SRAM 408. From the above description, the communication between the DRAM 204 and the NRAM 531 or the WRAM 532 may be implemented through two channels. A first channel is to directly connect the DRAM 204 with the NRAM 531 or the WRAM 532 through the IODAM 533. A second channel is to transfer the data between the DRAM 204 and the SRAM 408 through the GDMA 411 first, and then to transfer the data between the SRAM 408 and the NRAM 531 or the WRAM 532 through the MVDMA 534. Although it seems that the second channel requires more components and longer data streams, in fact, in some embodiments, the bandwidth of the second channel is much greater than that of the first channel. Therefore, the communication between the DRAM 204 and the NRAM 531 or the WRAM 532 may be more efficient through the second channel. Embodiments of the present disclosure may select a data transfer channel according to hardware conditions.

In other embodiments, a function of the GDMA 411 and a function of the IODMA 533 may be integrated in the same component. For the sake of description, the GDMA 411 and the IODMA 533 are viewed as different components in the present disclosure. For those skilled in the art, as long as functions and technical effects realized by components are similar to those of the present disclosure, the components shall fall within the scope of protection of the present disclosure. Further, the function of GDMA 411, the function of IODMA 533, a function of CDMA 410, and a function of MVDMA 534 may also be implemented by the same component.

The method for scheduling graph task provided in the present application is executed in the board card 10 shown in FIG. 1, and the graph task may include various types of deep learning and machine learning tasks, such as a neural network task including a plurality of task nodes. The graph task may be applied under complex scenarios in the fields of computer vision, speech, natural language processing, data mining, and the like.

On the basis of the hardware structure of the execution device, in order to more clearly understand the technical solution of the present application, the method for scheduling graph task of the prior art will be described in detail in the following.

A graph task is a task between a plurality of consecutive tasks represented using a graph structure. Each node in a graph structure corresponding to a graph task represents a task, and directed edges formed between nodes represent dependencies between tasks. The graph task may be a neural network task, and each task node in the graph task may be an operator (such as convolution, full connection, activation) in the neural network task.

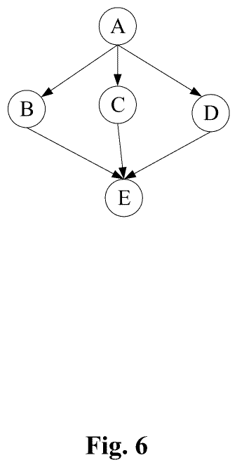

FIG. 6 is a schematic diagram of a graph structure of a graph task. As shown in FIG. 6, the graph structure includes five nodes A, B, C, D, and E, each of which represents a task, and A is connected to B, C, and D using directed edges, respectively, while B, C, and D are connected to E using directed edges, respectively. Based on the graph structure, it can be seen that A has a dependency relationship with B, C, and D, respectively; in other words, B, C, and D may execute operations only after A executes operations; and B, C, and D have a dependency relationship with E, respectively; in other words, E may execute operations only after B, C, and D have all executed operations.

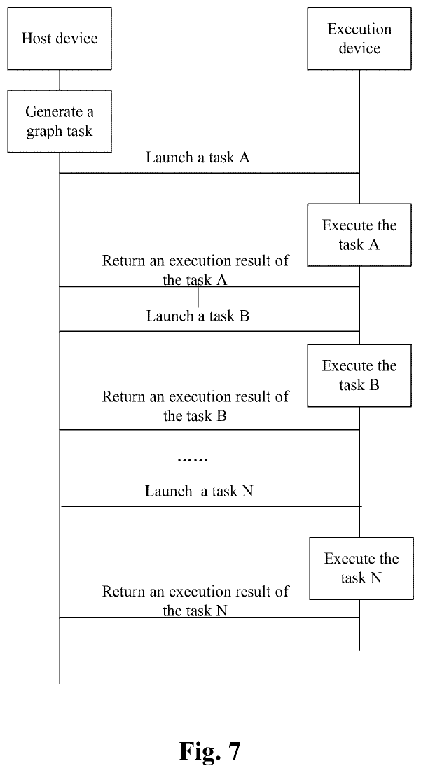

Based on having task dependencies in a graph task, FIG. 7 shows a flow chart of a method for scheduling graph task in the prior art. As shown in FIG. 7, in the prior art, when an execution device (abbreviated as a device) processes a graph task, a method for task scheduling is required to be provided through a host device (abbreviated as a host) to the execution device. In other words, after generating a graph task, the host device may sequentially launch each task to the execution device according to the graph structure in the graph task, and a processing unit of the execution device executes each task.

In order to enable the execution device to execute each task in accordance with the correct dependencies between tasks, the host device may perform task scheduling for the execution device; in other words, it is required that every time the execution device completes a task, the execution device returns a task execution result to the host device, and after obtaining the task execution result, the host device may determine a next task that may be executed according to the dependencies in the graph structure and launch the next task to the execution device to be executed. The host device may repeat the task delivery and task result reception until all tasks in the graph task have been executed.

Obviously, such a task scheduling method requires frequent interaction between the host device and the execution device, which is inefficient. With the increase in the number of tasks in the graph task and the complexity of the graph task itself, a lot of communication resources and time resources are required to be spend on delivering the task and returning the task result between the host device and the execution device, resulting in a surge in communication overhead and IO overhead. In addition, the computing resources of the execution device are stagnant during the time spent waiting for the host device to perform task delivery and task scheduling, which also reduces the utilization of the computing resources of the execution device, resulting in poor overall processing efficiency of the graph task.

In order to solve the overhead increase caused by the existing method for scheduling graph task mentioned above, in the present application, the host device launches the whole graph task to the execution device, and receives a processing result of the graph task uploaded by the execution device at one time after the execution device completes the execution of all the tasks in the graph task. As for the scheduling and execution of each task in the graph task, the maintenance of dependencies between tasks node in the graph task is automatically performed by the execution device.

Specifically, the execution device may determine the task execution state of the predecessor task having a dependency relationship with the current task in the graph task; the execution device may determine whether to execute the current task according to the task execution state of the predecessor task and the task execution state of the current task, where if the current task is determined to be executed, the execution device may update the task execution state of the current task after the current task is executed, so that the execution device may directly obtain the task execution state of the predecessor task of the current task before executing the current task, realizing the graph task scheduling processing on the execution device, thereby eliminating the need for the host device to perform task scheduling for the execution of tasks of the execution device, reducing communication and IO overhead and improving task operation efficiency.

Embodiments of the present application will be specifically described below with reference to the accompanying drawings and in conjunction with the various steps provided as above.

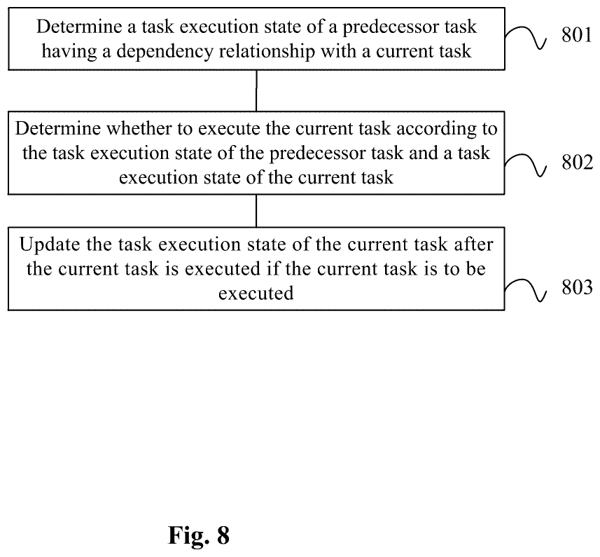

FIG. 8 is a flow chart of a method for scheduling graph task provided by the present application. The method for scheduling graph task may be applied to the computer hardware structure shown in FIG. 1. An execution device is configured to perform the method for scheduling graph task, which may be the aforementioned board card 10, and specifically may be the aforementioned chip 101. The external apparatus 103 in FIG. 1 may be the aforementioned host device that generates a graph task and launches the graph task to the execution device as a whole via the external interface apparatus 102, so that the execution device executes the graph task based on the scheduling method.

As described in FIG. 8, the method for scheduling graph task may include:
step 801, determining a task execution state of a predecessor task having a dependency relationship with a current task;
step 802, determining whether to execute the current task according to the task execution state of the predecessor task and a task execution state of the current task; and
step 803, updating the task execution state of the current task after the current task is executed if the current task is determined to be executed.

Specifically, after receiving the graph task launched by the host device, the execution device may, based on the dependency relationship between the tasks described in the graph task, first perform a check operation on the execution state of the predecessor task before executing the current task to determine the task execution state of the predecessor task having a dependency relationship with the current task.

Then, the execution device may determine whether to execute the current task according to the task execution state of the predecessor task and the task execution state of the current task.

Finally, after the current task is executed, the execution device may perform an updating operation on the execution state of the current task to update the task execution state of the current task.

The execution state of a task may include completed, executing, and not executed. Optionally, when the execution state of the predecessor task of the current task is completed and the task execution state of the current task is not executed, the execution device may determine to execute the current task and may update the task execution state of the current task after the execution of the current task is completed. Otherwise, if the execution state of the current task is completed, and/or the execution state of the predecessor task of the current task is executing or not executed, it may be determined at this time that the current task is executed. In embodiments of the present application, dependencies of task nodes in the graph task may be determined by the execution device, which may ensure the order as well as the correctness of the execution of the graph task. Besides, the execution device may automatically perform the checking and updating of the state of the task; and during the execution of the graph task, the execution device does not need to interact with the host device, which may reduce the communication and IO overhead and improve the execution efficiency of the graph task.

Further, the host device may configure a state check operation and a state update operation for the task by means of an operation identifier, and deliver the indication information to the execution device at one time together with the graph task, thereby reducing the communication and IO overhead and improving the execution efficiency of the graph task.

Optionally, each task may correspond to a task descriptor, which may be used to record various information about the task, including, but not limited to, the operation identifier described above, the dependencies between tasks, the size of the task, and the like. The task descriptor of the task may be generated when the graph task is constructed, and the task descriptor may also be delivered to the execution device along with the graph task. The size of the task is the resource allocation of computing resources required for the graph task. The dependencies may include: the task structure of the graph task, i.e., the number of input edges or the number of output edges on which the tasks in the graph task depend, as well as an indication indicating which tasks the task node is the predecessor node of, i.e., the dependencies may be used to determine the predecessor task of the task.

In other words, by analyzing the information in the task descriptor of the graph task, the execution device may determine the dependencies between the tasks. In optional embodiments, the execution device may obtain a task descriptor of each task in the graph task first, where the task descriptor contains dependency relationship information between the tasks in the graph task; and the execution device may determine the predecessor task having a dependency relationship with the current task based on the task descriptor of each task in the graph task.

Specifically, the task descriptor may include at least one bit to indicate a dependency relationship; for example, the task descriptor may record the number of input edges of the task node to indicate the number of predecessor tasks on which the task node depends; and/or the task descriptor may record the number of output edges of the task node to indicate which tasks the task node is the predecessor node of. Further, the task descriptor may also include a mapping relationship between each input edge and a predecessor node of that input edge.

As shown in FIG. 6, the number of input edges of tasks B, C, and D is 1, so descriptors of tasks B, C, and D may include the number of their input edges and an input task node A corresponding to the input edges respectively. The number of input edges of a task E is 3, so a descriptor of the task E may include may include the number of input edges, which is 3, as well as each input edge and its corresponding input task node. An edge with an arrow pointing to the task in FIG. 6 is an input edge.

In the embodiments of the present application, the host device may configure a task descriptor of each task in the graph task. For example, a driver running on the host device may configure the task descriptor of each task and launch the task descriptor together with the graph task to the execution device. After obtaining the graph task as shown in FIG. 6, the execution device may determine a predecessor task and a successor task of each task based on the dependency relationship contained in the task descriptor of each task, and the execution device may determine the execution order of each task in the graph task based on the dependency relationship between tasks, for example, the execution device may execute a task A first, then execute tasks B, C, and D, and finally execute a task E.

By analyzing the dependency relationship, it may be known that the task A may be the predecessor task of the tasks B, C, and D, while the tasks B, C, and D may be the predecessor tasks of the task E. After determining that the task A is the predecessor task of the tasks B, C, and D, and before executing the tasks B, C, and D, the execution device needs to first determine the task execution state of the task A to ensure that the task A has been executed. Similarly, after determining that the tasks B, C, and D are the predecessor tasks of the task E, and before executing the task E, the execution device needs to first determine the task execution states of the tasks B, C, and D to ensure that the tasks B, C, and D have been executed.

Based on this, the execution device may determine a task graph scheduling strategy as shown below:
the execution order of the task A includes: determining the task execution state of the task A→executing the task A→updating the task execution state of the task A;
the execution order of the tasks B, C, and D includes: determining the task execution state of the task A and determining the task execution states of the tasks B, C, and D→executing the tasks B, C, and D→updating the task execution states of the tasks B, C, and D; and
the execution order of the task E includes: determining the task execution states of the tasks B, C, and D and determining the task execution state of the task E→executing the task E→updating the task execution state of the task E.

Then, the execution device may allocate corresponding computing resources to each task according to the above-mentioned task execution orders and the scheduling strategy of each task, so that a plurality of computing resources may be used to execute corresponding tasks until the task execution state of the task E is updated to be completed. The execution device may return the execution result of the graph task to the host device when the graph task has been executed.

In the above process, when the execution device determines that the current task cannot be executed based on the task execution state of the predecessor task and the task execution state of the current task, the step is returned to the determining the task execution state of the predecessor task having the dependency relationship with the current task until it is determined that the current task can be executed based on the task execution state of the predecessor task and the task execution state of the current task.

Here, the execution of the task B in the graph task is still taken as an example. After the execution device allocates corresponding scheduling resources to the task B, the computing resources may only start to perform an operation on the task B after it is determined that the task execution state of the task A is completed. At this time, if the execution device is informed that the task execution state of the task A is not completed, then the computing resources are not used to perform an operation on the task B. The execution device reacquires the task execution state of the task A after a predetermined time, and triggers the operation on the task B until it is determined that the task execution state of the task A is completed.

Through such a scheduling method, the execution device may complete the scheduling of each task by itself according to the received graph task to ensure that each task may be executed in the order according to the dependency relationship. Compared with the existing technology, the execution device does not need to carry out scheduling communications repeatedly with the host device, and its scheduling overhead is small. Besides, since a plurality of computing resources are used to process each task separately, while ensuring high scheduling efficiency, the computing resources of the execution device also have a shorter pause time when processing the task, effectively improving the overall processing efficiency of the task.

Optionally, a hardware register may be set in the execution device to store task execution states of different tasks. In optional embodiments, task execution states of different tasks are stored in different register bits of a register. When the register bit is recorded as a first state value, a task execution state of a task corresponding to the register bit is a finished state; and when the register bit is recorded as a second state value, the task execution state of the task corresponding to the register bit is an unfinished state.

Specifically, after the graph task is launched to the execution device, the execution device may first initialize a state value of each register bit in the register; in other words, according to the graph structure in the graph task, the execution device may allocate a corresponding register bit to each task to establish a mapping relationship between the task and the register bit.

On this basis, when the execution device determines whether to execute the current task according to the task execution state of the predecessor task and the task execution state of the current task, specific steps may be as follows: the execution device acquires a register bit of the predecessor task and a register bit of the current task in the register; and the execution device determines to execute the current task when the register bit of the predecessor task is recorded as a first state value and the register bit of the current task is recorded as a second state value.

Specifically, the task B in FIG. 6 is still taken as an example. Based on the mapping relationship in the initialization phase, the execution device may determine a register bit of the predecessor task A of the task B, and read and obtain state values of the register bits of the task A and the task B; and at this time, if the state value of the register bit of the task A is the first state value, and the state value of the register bit of the task B is the second state value, the execution device determines that the task B may be executed.

Accordingly, in order to execute the entire graph task smoothly and to facilitate the execution of subsequent tasks, in an optional implementation, after the task execution is completed, the execution device further updates the register bit of the current task to the first state value.

Specifically, after the execution of the task B is completed, the execution device may update the state value of the register bit corresponding to the task B from the second state value to the first state value according to the aforementioned mapping relationship to represent that the task execution state of the task B is completed.

Optionally, the execution device may further perform a corresponding state check or state update operation based on an operation identifier in a task descriptor to realize the check or update of the corresponding register bit in the register.

Optionally, the operation identifier may include an execution state updating identifier for updating the execution state of the current task. The execution device may obtain the execution state updating identifier in the task descriptor of the current task; after the current task is executed, the execution device may update the task execution state of the current task according to the execution state updating identifier of the current task.

Optionally, the operation identifier may further include an execution state checking identifier for determining the task execution state of the predecessor. The execution device may obtain the execution state checking identifier in the task descriptor of the current task and determine the task execution state of the predecessor task having the dependency relationship with the current task based on the execution state checking identifier of the current task.

Specifically, when the host device generates the task descriptor, the dependency relationship between the tasks may be considered on the one hand, and on the other hand, the operation of changing the task execution state corresponding to each task will also be considered. Each task descriptor may also include a number of types of operation identifiers, where the execution state updating identifier may indicate to update the execution state of the task, and the execution state checking identifier may indicate to read and determine (check) the execution state of the task. The execution device may perform a corresponding operation depending on whether this operation identifier is enabled or not.

Taking the graph task shown in FIG. 6 as an example, since the task A is a first node, the execution state updating identifier in the task descriptor of the task A may be configured to be enabled (for example, the execution state updating identifier in the task descriptor of the task A may be configured to 1), which means that the state of the task A is to be updated after the task A has been executed. It may be determined that the tasks B, C, and D are intermediate nodes based on the dependency relationship of the graph task, where the task A is the predecessor task, and the task E is the successor task. Therefore, the execution state updating identifiers and the execution state checking identifiers in the task descriptors of the tasks B, C, and D may be configured to be enabled (for example, the execution state updating identifiers and the execution state checking identifiers in the task descriptors of the tasks B, C, and D may be configured to 1). The enablement of the execution state updating identifier indicates that the execution states of the tasks B, C, and D are required to be updated accordingly after the execution of tasks B, C, and D are finished, respectively. The enablement of the execution state checking identifier indicates that the state determination operation of the task A is required to be executed accordingly before the tasks B, C, and D are executed, respectively. Since the task E serves as a termination node with predecessor tasks B, C, D, but no successor tasks, the execution state updating identifier and the execution state checking identifier in the task descriptor of the task E may be configured to be enabled (for example, the execution state updating identifier and the execution state checking identifier in the task descriptor of the task E may be configured to 1). In other words, before the execution of the task E, it is necessary to execute the state determination operations of the tasks B, C, D accordingly, and after the execution of the task E is finished, the state update operation of the task E is executed. Whether the operation identifier in the task descriptor is enabled or not is configured by the host device.

Based on this, after obtaining the graph task and the corresponding task descriptor, the execution device may directly update the register bit of the register corresponding to the task based on the execution state updating identifier in the task descriptor. In other words, the execution device may, before executing the current task, check the state of the predecessor task of the current task based on the execution state checking identifier in the task descriptor of the current task to determine the execution state of the predecessor task of the current task. Besides, the execution device may, after executing the current task, update the state of the current task based on the execution state updating identifier in the task descriptor of the current task to update the register bit of the current task to the first state value.

Optionally, the execution device may include a task scheduler and at least one computing resource, where the computing resource may be a multi-core processor. The task scheduler is configured to schedule and allocate the graph task to at least one computing resource, so that the processor may execute the corresponding task. In the embodiments of the present disclosure, task nodes in the graph task may be dispatched to corresponding computing resource for execution, and the execution state update operation and the execution state determination operation described above may be performed by the task scheduler.

For example, for the graph task in FIG. 6, the task scheduler may first allocate the task A to a computing resource A, so that the computing resource A is adopted to perform computing processing. After the computing resource A completes the execution of the task A, the task scheduler may update the state of the task A. The task scheduler is also configured to perform a task state determination operation to determine whether the execution of the predecessor task A is completed before the computing resources B, C, and D perform the commutating processing on the tasks B, C, and D. When it is determined that the execution of the task A is completed, the task scheduler may schedule the tasks B, C, and D to the computing resources B, C, and D, respectively, so that the computing resources B, C, and D are adopted to perform computing processing. After the execution of the tasks B, C, and D is completed, the task scheduler may also be used to perform state update operations on the tasks B, C, and D, respectively. When the execution device performs task scheduling for each task, a plurality of computing resources may perform computing processing simultaneously based on the task dependency relationship. For example, after the computing resource A finishes the computing on the task A, the computing resources B, C, and D may simultaneously process their respective corresponding tasks B, C, and D. In this way, the task may be executed quickly to improve the overall execution efficiency of the graph task. Further, the task scheduler is further used to perform the task state determination operation based on the task description of the task E to determine whether the execution of the successor tasks B, C, and D is completed. When it is determined that the execution of the successor tasks B, C, and D is completed, the task scheduler may schedule the task E to a computing resource E, so that the computing resource E is adopted to perform computing processing. The task scheduler may also be used to update the state of the task E after the execution of the task E is completed.

By adopting the method for scheduling graph task provided by embodiments of the present disclosure, the task execution state of the predecessor task having the dependency relationship with the current task is determined; whether to execute the current task is determined according to the task execution state of the predecessor task and the task execution state of the current task; and if the current task is determined to be executed, the task execution state of the current task is updated after the current task is executed, so that the execution device may directly obtain the task execution state of the predecessor task of the current task before executing the current task, realizing the graph task scheduling processing on the execution device, thereby eliminating the need for the host device to perform task scheduling for the execution of tasks of the execution device, reducing communication overhead, and improving task operation efficiency.

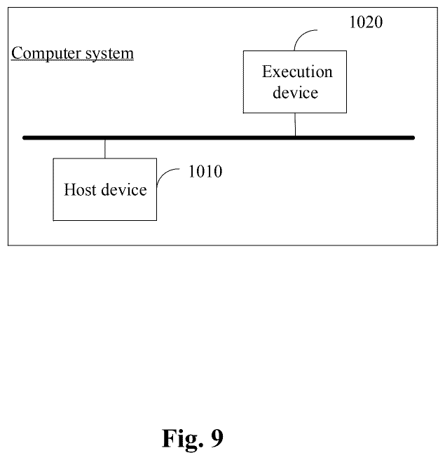

FIG. 9 is a schematic diagram of a hardware structure of a computer system provided by the present application. As shown in FIG. 9, the computer system includes a host device 1010 and an execution device 1020.

The host device 1010 is configured to configure a task descriptor for a graph task and launch the graph task and the corresponding task descriptor of the graph task to the execution device, where the task descriptor contains dependency relationship information between tasks in the graph task.

The execution device 1020 is configured to determine a task execution state of a predecessor task having a dependency relationship with the current task. The execution device is further configured to determine whether to execute the current task according to the task execution state of the predecessor task and the task execution state of the current task, where if the current task is determined to be executed, the execution device is configured to update the task execution state of the current task after the current task is executed.

The execution device 1020 in the computer system may be used to implement the method described in the first embodiment.

The present application also provides an execution device including a memory and a processor.

The memory is configured to store instructions executable by the processor.

The processor is configured to determine a task execution state of a predecessor task having a dependency relationship with a current task; determine whether to execute the current task according to the task execution state of the predecessor task and a task execution state of the current task; and update the task execution state of the current task after the current task is executed if the current task is determined to be executed.

In addition, the processor is further configured to implement the method described in the preceding embodiment 1.

The present application further provides a computer-readable storage medium, on which a computer execution instruction is stored, where the method for scheduling graph task as described in any one of the first embodiment is implemented when the computer execution instruction is executed by the processor.

The computer-readable storage medium may be any usable medium or data storage device that may be accessed by a computer, including, but not limited to, magnetic memories (such as a floppy disk, a hard disk, a magnetic tape, and a magnetic optical (MO)), optical memories (such as a CD (Compact Disc), a DVD (Digital Video Disc), a BD (Blu-ray Disc), and an HVD (Holographic Versatile Disc)), and semiconductor memories (such as an ROM (Read-Only Memory), an EPROM (Electronic Program Read Only Memory), an EEPROM (Erratic Extensible Program Random Object Memory), an NAND (Not-AND) FLASH, and a solid-state disk (SSD)).

The present application further provides a computer program product including a computer program that, when executed by a processor, implements the method for scheduling graph task as described in any one of the first embodiment.

Those skilled in the art should understand that the embodiments of the present disclosure may be provided as a method, a system, or a computer program product. Therefore, the embodiments of the present disclosure may be implemented wholly in the form of hardware, or wholly in the form of software, or in the form of combining software and hardware. Additionally, the embodiments of the present disclosure may be implemented in the form of the computer program product that is executed in one or more computer-usable storage medium (which may include but be not limited to a magnetic disk storage and an optical storage) that store computer-usable program codes.

The present application is described according to the flowcharts and/or the block diagrams of the method, the equipment (system), and the flowchart of the present disclosure. It will be understood that each process and/or block in flowcharts and/or block diagrams, and combinations of processes and/or blocks in the flowcharts and/or block diagrams, may be implemented by the computer-executable instructions. These computer-executable instructions may be provided to a processor of a general-purpose computer, a special-purpose computer, an embedded processor, or other programmable data processing device to produce a machine, so the instructions executed by the processor of the computer or other programmable data processing device may produce a device configured to implement the functions specified in a process or a plurality of processes in a flowchart and/or a block or a plurality of blocks in a block diagram.

These computer-executable instructions may also be stored in a computer-readable memory that directs a computer or other programmable data processing device to operate in a particular manner, such that the instructions stored in the computer-readable memory produce a manufactured product including an instruction device configured to implement the functions specified in a process or a plurality of processes in a flowchart and/or a block or a plurality of blocks in a block diagram.

These computer-executable instructions may also be loaded onto a computer or other programmable data processing device, such that a series of operation steps are performed on the computer or other programmable device to produce the processing implemented by the computer, therefore, an instruction executed on the computer or other programmable device may provide steps for implementing the functions specified in a process or a plurality of processes in a flowchart and/or a block or a plurality of blocks in a block diagram.

What is claimed:

1. A method for scheduling graph task, comprising:
determining, by an execution device, a task execution state of a predecessor task having a dependency relationship with a current task;
determining, by the execution device, whether to execute the current task according to the task execution state of the predecessor task and a task execution state of the current task; and
updating, by the execution device, if the current task is determined to be executed, the task execution state of the current task after the current task is executed.

2. The method of claim 1, wherein task execution states of different tasks are stored in different register bits of a register; wherein
when the register bit is recorded as a first state value, the task execution state of a task corresponding to the register bit is a finished state; and
when the register bit is recorded as a second state value, the task execution state of the task corresponding to the register bit is an unfinished state.

3. The method of claim 2, wherein the determining whether to execute the current task according to the task execution state of the predecessor task and the task execution state of the current task comprises:
acquiring, by the execution device, a register bit of the predecessor task and a register bit of the current task in the register, and
executing, by the execution device, the current task when the register bit of the predecessor task is recorded as a first state value and the register bit of the current task is recorded as a second state value.

4. The method of claim 2, wherein the updating the task execution state of the current task after the current task is executed comprises:
updating, by the execution device, the register bit of the current task to the first state value.

5. The method of claim 1, further comprising:
obtaining, by the execution device, an execution state updating identifier in a task descriptor of the current task; and
updating, by the execution device, the task execution state of the current task according to the execution state updating identifier of the current task after the current task is executed.

6. The method of claim 1, further comprising:
obtaining, by the execution device, an execution state checking identifier in a task descriptor of the current task; and
determining, by the execution device, the task execution state of the predecessor task having the dependency relationship with the current task according to the execution state checking identifier of the current task.

7. The method of claim 1, wherein if it is determined that the current task cannot be executed based on the task execution state of the predecessor task and the task execution state of the current task, the step is returned to the determining the task execution state of the predecessor task having the dependency relationship with the current task, until it is determined that the current task can be executed based on the task execution state of the predecessor task and the task execution state of the current task.

8. The method of claim 1, further comprising:
obtaining, by the execution device, a task descriptor of each task in the graph task, where the task descriptor contains dependency relationship information between tasks in the graph task; and
determining, by the execution device, the predecessor task having the dependency relationship with the current task according to the task descriptor of each task in the graph task.

9. A computer system, comprising a host device and an execution device, wherein
the host device is configured to configure a task descriptor for a graph task and launch the graph task and a corresponding task descriptor of the graph task to the execution device, wherein the task descriptor contains dependency relationship information between tasks in the graph task; and
the execution device is configured to determine a task execution state of a predecessor task having a dependency relationship with the current task, the execution device is further configured to determine whether to execute the current task according to the task execution state of the predecessor task and a task execution state of the current task, wherein if the current task is determined to be executed, the execution device is configured to update the task execution state of the current task after the current task is executed.

10. An execution device, comprising a memory and a processor, wherein
the memory is configured to store instructions executable by the processor; and
the processor is configured to
determine a task execution state of a predecessor task having a dependency relationship with a current task,
determine whether to execute the current task according to the task execution state of the predecessor task and a task execution state of the current task, and
update the task execution state of the current task after the current task is executed if the current task is determined to be executed.

11. (canceled)

12. (canceled)

13. The method of claim 1, wherein the method comprising:
receiving, by the execution device, a whole graph task from a host device before scheduling graph task, wherein the whole graph task comprises a plurality of nodes and directed edges, each node in a graph task represents a task, and directed edges formed between nodes represent dependencies between tasks.

14. The method of claim 1, wherein the method further comprising:
outputting, by the execution device, a processing result of the graph task after the execution device completes the execution of all the tasks in the graph task.

15. The computer system of claim 9, wherein
the host device is configured to launch a whole graph task to the execution device, wherein the whole graph task comprises a plurality of nodes and directed edges, each node in a graph task represents a task, and directed edges formed between nodes represent dependencies between tasks.

16. The computer system of claim 9, wherein
the execution device is configured to output a processing result of the graph task to the host device, after the execution device completes the execution of all the tasks in the graph task.

17. The execution device of claim 10, wherein
the processor is configured to receive a whole graph task from a host device before scheduling graph task, wherein the whole graph task comprises a plurality of nodes and directed edges, each node in a graph task represents a task, and directed edges formed between nodes represent dependencies between tasks.

18. The execution device of claim 10, wherein
the processor is configured to output a processing result of the graph task after the execution device completes the execution of all the tasks in the graph task.
